(19) United States
(12) Patent Application Publication
(10) Pub. No.: US 2012/0133168 A1
(43) Pub. Date: May 31, 2012

(54) SLIDING GRAB HANDLE

(75) Inventor: Frank Ardigo, Saint Clair, MI (US)

(73) Assignee: Faurecia Interior Systems, Inc., Auburn Hills, MI (US)

(21) Appl. No.: 12/955,345

(22) Filed: Nov. 29, 2010

(51) Int. Cl. B60N 3/02

(52) U.S. Cl. 296/1.02; 296/152

(57) ABSTRACT

A slidable apparatus that may form an interior vehicle door grab handle. The slidable apparatus includes a handle and handle support, wherein the handle support is fixed to an interior portion of a vehicle door, whereby the handle can be positioned initially in a rearward position so that adequate torque assist is provided to a passenger opening a vehicle door from the inside, and as the door opens, is movable to a more forward position so that the passenger can maintain hold on the grab handle throughout the opening process.

### FIELD OF THE INVENTION

The present invention relates generally to interior vehicle door handles, and more particularly, to a slidable apparatus that may form an interior vehicle door grab handle.

### BACKGROUND OF THE INVENTION

Interior door trim panels are normally supplied with grab handles that function as a sturdy handle for passengers to use while opening a door or pulling the door closed. The location of the grab handle is normally in the upper rearward section of the door panel in order to provide the passenger with adequate torque to push open or pull close the door. The further the grab handle is from the hinges, the more torque assist the passenger can obtain.

As a door is opened, the passenger typically tries to hold onto the grab handle. However, as the door opens, the grab handle position tends to move out of reach of the passenger due to the opening angle being larger at the rearward end of the door than at the hinges. Also, when a passenger tries to reach for the grab handle in order to close the door, it can be out of reach when it is near the rearward edge of the door. If the grab handle location were closer to the hinges, it would be easier to reach for the passenger. However, if the grab handle were closer to the hinges, there would be less torque assist and require greater effort to open and close the door.

Thus there is a need for a grab handle that is located and remains in a convenient position for a user to reach and hold and provides a high level of torque assist regardless of its position.

### SUMMARY OF THE INVENTION

In accordance with one aspect of the present disclosure, a sliding grab handle for the interior of a vehicle door is provided which can be positioned initially in a rearward position so that adequate torque assist is provided to a passenger opening the door from the inside, and as the door opens, is movable to a more forward position so that the passenger can maintain hold on the grab handle throughout the opening process. In this way the passenger need not release the grab handle and the grab handle does not move out of reach of the passenger as the door opens. In one embodiment the grab handle is configured and operable to remain in a forward position upon release of the handle by the passenger. In this way the handle is in a good ergonomic position for a passenger to reach and use to close the door upon reentry to the car.

Thus, a sliding grab handle may also be provided which can be positioned initially in a forward position to accommodate the situation in which a passenger gets into the car and needs to close the door. The passenger is able to hold onto the grab handle in the forward position which is easy to reach in the “door open” position. As the door is pulled closed by the passenger, the grab handle slides to a more rearward position, providing extra torque throughout the door closing process. The grab handle may be configured and operable to remain in a rearward position upon door closure with the passenger inside the car. In this way the handle is in a good ergonomic position for a passenger to reach and use to open the door upon exit from the car.

In one embodiment a vehicle door is provided having a handle support and sliding handle disposed on a passenger compartment side of the vehicle door.

In accordance with one embodiment, a sliding grab handle apparatus includes a slidable handle and a handle support. The slidable handle is mounted on and movable along at least a portion of the length of the handle support. The handle support is mounted substantially horizontally on the interior of a vehicle passenger door in a location and position suitable for a standard grab handle, for example, between the top of the door window sill and an interior arm rest. The slidable handle may be mounted on the handle support in any suitable manner. For example the handle may include a bore or aperture oriented along a longitudinal axis of the handle, in which the handle support may be received. The handle support may be attached at each end to the door interior, so that the handle is freely slidable forward and backward substantially horizontally between the two ends of the handle support.

In another embodiment the handle support may be one or more elongated sections mountable to an interior surface of a vehicle door. The handle support may include one or more channels, slots or tracks along a long axis thereof. A handle mountable on the handle support may include one or more corresponding tabs or glides which slidably engage the slots or tracks such that the handle is movable forward and backward as needed.

In accordance with a one embodiment a sliding grab handle apparatus includes a handle slidably mounted on an interior surface of a vehicle door using complementary rails fixed on the handle and vehicle door surfaces. In one embodiment a sliding handle having a rail mounted on an inside surface thereof is configured to engage a fixed rail mounted on a fixed support inside a passenger door. The sliding handle rail is coupled to the fixed rail. The sliding handle is slidable forward and back along the fixed rail.

In a further embodiment, the sliding handle is configured to be securable in one or more fixed positions, such as a rearward, forward and/or intermediate position along the length of the fixed support. To this end one or more retention elements may be employed in conjunction with the sliding door handle apparatus. For example, at least one detent may be provided on elements of the sliding door handle apparatus, such as on door interior trim panel or support surfaces proximal the sliding door handle, or on the sliding door handle to engage corresponding detent elements on the adjacent trim panel surfaces, and the like, to allow the sliding handle to be temporarily secured in selected positions. In another embodiment, the retention element(s) may comprise one or more magnets employed to engage the sliding handle in a stationary position.

In one embodiment, the subject matter includes movable and/or removable retention elements to permit a passenger to customize handle stop positions.

In a further embodiment the sliding grab handle apparatus is biased so that the sliding handle remains at rest in a rearward position and under tension when in a detented, forward position. In one embodiment the apparatus includes a spring element located on the sliding or fixed rail operable to create the aforementioned bias. It will be apparent to the skilled artisan that the spring element may be positioned so that the handle will be at rest in the forward position and under tension in the rearward position.

Advantages of the present disclosures include improved ergonomics, egress and ingress for vehicle passengers. The subject matter herein is exceptionally beneficial to elderly passengers, children and any person who might experience difficulty opening/closing a car door. In addition, the present subject matter is useful in that it allows a passenger to maintain a grip on the door for a longer period of time, thus ameliorating situations that normally might jerk the door from the grasp of the passenger, such as wind gusts, downhill parking orientation and the like. It will be apparent that the presently disclosed subject matter is particularly useful when employed in larger vehicles having heavy and/or long doors, such as large coupes and trucks.

### BRIEF DESCRIPTION OF THE DRAWINGS

To assist those of ordinary skill in the relevant art in making and using the subject matter hereof, reference is made to the appended drawings, wherein:

FIG. 1 is a front view of a sliding grab handle apparatus on an interior side of a vehicle passenger door in accordance with one or more embodiments of the present disclosure, wherein a handle is shown in ghost to depict the rearward position;

FIG. 1A is a cross-sectional view of the sliding grab handle apparatus of FIG. 1 taken through the line A-A′ in accordance with one or more embodiments of the present disclosure;

FIG. 2 is an elevated front perspective view of a sliding grab handle apparatus in accordance with one or more embodiments of the present disclosure;

FIG. 3 is a rear perspective view of the sliding grab handle apparatus of FIG. 2 in accordance with one or more embodiments of the present disclosure;

FIG. 4 is a cross-sectional view of a sliding grab handle apparatus in accordance with one or more embodiments of the present disclosure;

FIG. 5 is a perspective view of a support panel with detents and handle substrate with a corresponding detent engaging element in accordance with one or more embodiments of the present disclosure;

FIG. 6 is a rear perspective view of a sliding grab handle apparatus in accordance with one or more embodiments of the present disclosure;

FIG. 7 is a front view of a sliding grab handle apparatus on an interior side of a vehicle passenger door, with arrows indicating potential movement fore and aft, in accordance with one or more embodiments of the present disclosure;

FIG. 7A is a cross-sectional view of the sliding grab handle apparatus of FIG. 7 taken through the line B-B′ in accordance with one or more embodiments of the present disclosure;

FIG. 7B is a side view of the sliding grab handle apparatus of FIG. 7 showing a glide of the handle in ghost in accordance with one or more embodiments of the present disclosure; and

FIG. 8 is a front view of a sliding grab handle apparatus on an interior side of a vehicle passenger door showing glides of the handle in ghost in accordance with one or more embodiments of the present disclosure.

### DETAILED DESCRIPTION

In the following description, for purposes of explanation, specific numbers, materials and configurations are set forth to provide a thorough understanding of the invention. It will be apparent to one having ordinary skill in the art that the invention may be practiced without these specific details. In some instances, well-known features may be omitted or simplified so as not to obscure the present invention.

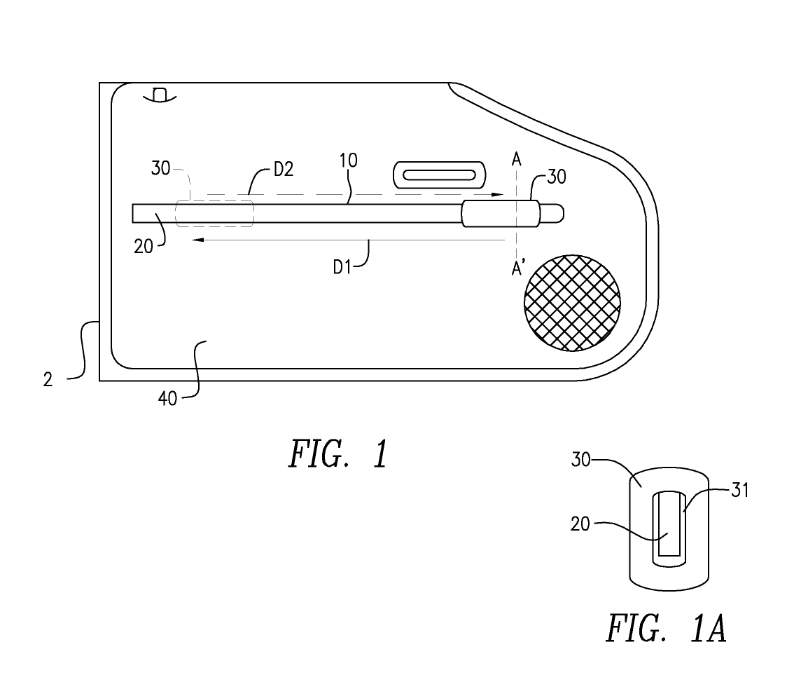

Now referring to FIG. 1, a vehicle door 2 is shown which includes a sliding grab handle apparatus 10 including a handle support 20 and slidable handle 30. The slidable handle 30 is mounted on and movable along at least a portion of the length of the handle support 20, as shown by the arrows D1 and D2 indicating rearward and forward directions, respectively. The handle support 20 is mounted substantially horizontally on an interior, passenger compartment-facing side of the vehicle door in a location and position suitable for a standard grab handle, for example, between the top of the door window sill and an interior arm rest (not shown). The slidable handle 30 may be mounted on the handle support 20 in any suitable manner. Now referring to FIG. 1A, the slidable handle 30 may include a bore or aperture 31 oriented along a longitudinal axis of the handle 30, in which the handle support 20 may be received. The handle support 20 may be attached at each end to the vehicle door 2, so that the slidable handle 30 is freely movable forward and backward substantially horizontally between the two ends of the handle support 20. The handle support 20 may be mounted to a vehicle door interior panel 40. It will be apparent to those skilled in the art that the slidable handle 30 need not fully enclose the handle support 20 to provide secure and slidable engagement therewith.

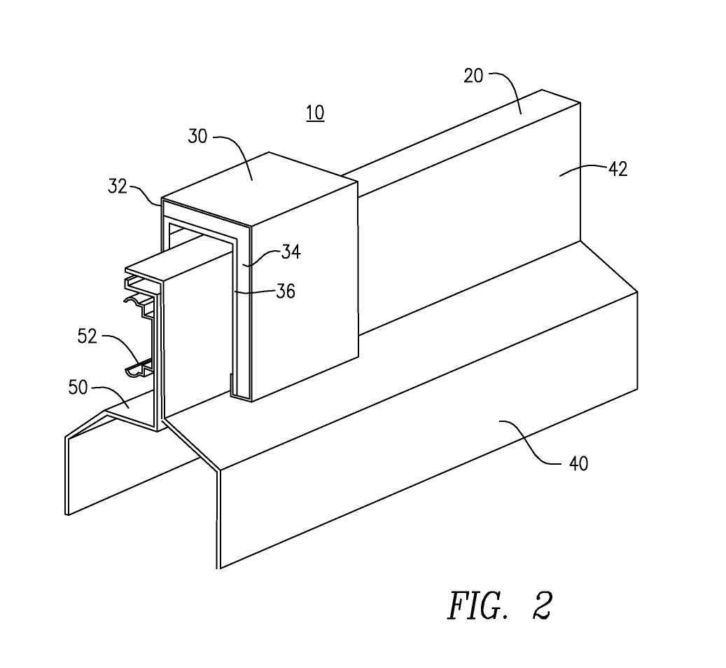

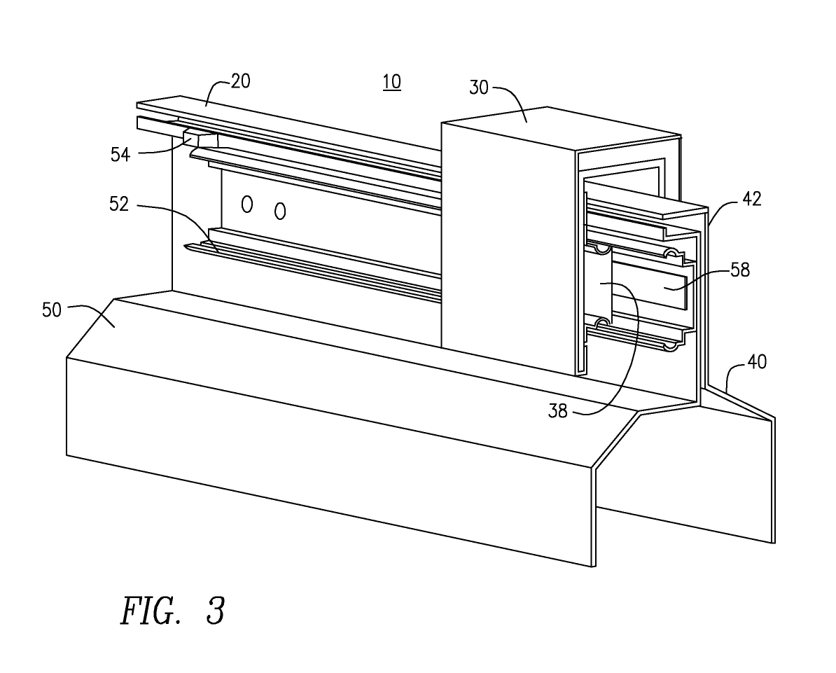

Now referring to FIGS. 2 and 3, an alternate embodiment of a sliding grab handle apparatus 10 includes a handle support and sliding handle 30. Handle support 20 may include a handle guide 42 extending vertically with respect to a vehicle floor, a support panel 50 and a rail 52 mounted along an exterior side of support panel 50. Guide 42 may be an extension of an interior door panel 40 or may be a separate element mounted on the passenger compartment side of the vehicle door 2. Sliding handle 30 may include an exterior skin 32, an intermediate layer 34, a substrate 36 and a handle rail 38 mounted on the substrate 36 of the handle 30.

The skin 32 is attached to the intermediate layer 34 using, for example, an adhesive or flame bonding. The intermediate layer 34 is attached to the substrate 36, for example, using an adhesive. The substrate 36 forms the base for the structure of the sliding handle 30 and may be any suitable material such as metal, plastic, wood or the like. The skin 32 can be any suitable material such as leather, imitation leather material such as but not limited to imitation leather formed from thermoplastic polyolefin (TPO), polyvinyl chloride (PVC) or polyurethane (PU), or the like. The intermediate layer 34 may be a soft material such as foam, cloth or the like. The intermediate layer 34 can comprise an open or closed-cell, non-porous foam structure, which results in a less absorbent, firmer material that may permit skiving various profiles therein. In one embodiment the foam layer 24 comprises a polypropylene foam having the aforementioned properties. It will be apparent to a skilled artisan that any suitable foam may be employed, such as polyurethane, PVC foam and the like.

Support panel 50 may be located on the side of the interior door panel 40 that faces opposite the passenger compartment of a vehicle. Support panel 50 is configured and positioned to provide structural support to the guide 42 of handle support 20. With reference to FIG. 3, as is discussed further hereinbelow, support panel 50 may include one or more retention elements 54 to engage the sliding handle 30 in a fixed position, and/or a biasing element 58.

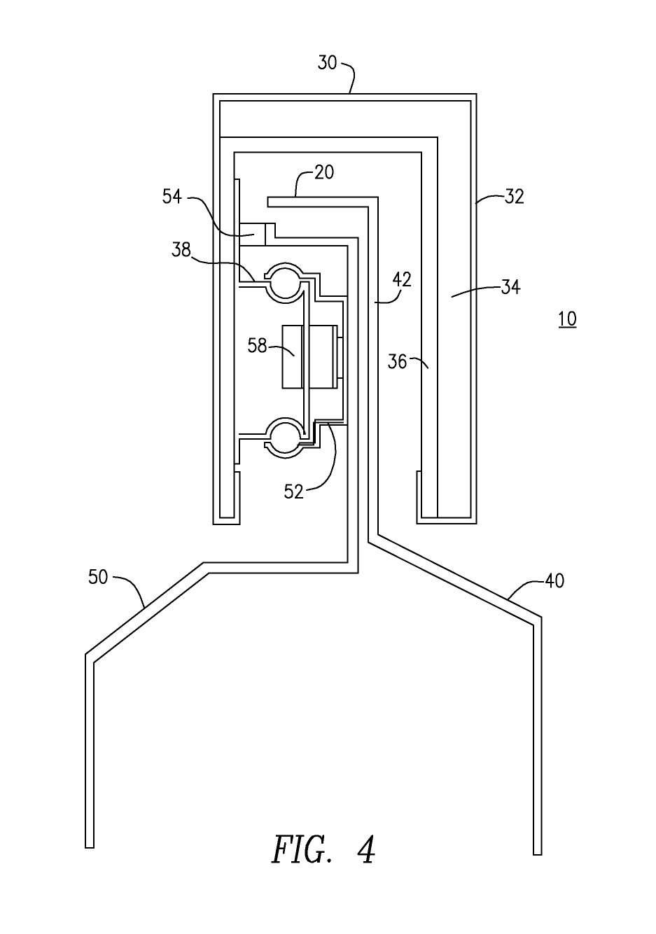

With further reference to FIG. 4, sliding handle rail 38 is coupled to the handle support rail 52 such that the sliding handle 30 is slidable forward and back along the handle support rail 52. Rails 38 and 52 may be any suitable rails providing slidable engagement, such as those employed in sliding drawers.

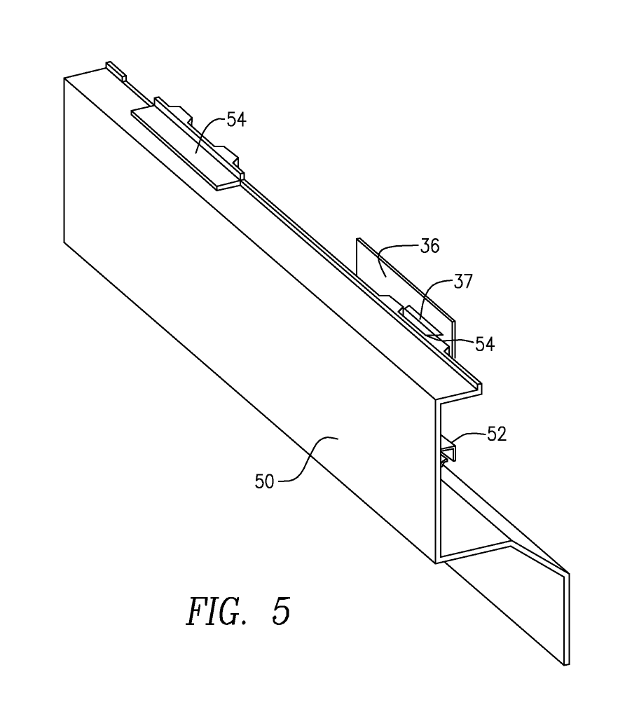

Now referring to FIG. 5, support panel 50 may include one or more retention elements which may be detents 54 operable to engage one or more corresponding detent element(s) 37 located on a portion of the sliding handle 30. Corresponding detent element 37 may be for example a tab extending from the surface of substrate 36. It will be apparent to those having ordinary skill in the art that the detents 54 may be located on the sliding handle substrate 36 and the corresponding detent element(s) 37 may be located on the support panel 50. It will also be apparent the detents 54 and corresponding detent element(s) may be positioned at other suitable locations on the substrate 36 and at positions on or adjacent the interior trim panel 40 adjacent to the substrate 36. By employing detents 54 and corresponding detent elements 37 the sliding handle 30 is configured to be securable in one or more fixed positions, such as a rearward, forward and/or intermediate position along the length of the handle support 20.

In a further embodiment one or more detents 54 may be removably fixed to the support panel 50. For example, detents 54 may include a clip operable to engage an edge of the support panel 50. Detents 54 may be designed according to old and well-known techniques to snap-fit to the support panel 50 or other suitable elements. In this way the location at which the sliding handle 30 may be temporarily fixed with respect to the handle support 20 may be adjusted.

It will be apparent to the skilled artisan that other retention elements may be employed and removably fixed to the sliding handle 30, handle support 20 or other elements. Suitable retention elements include magnets, clips, hooks and the like.

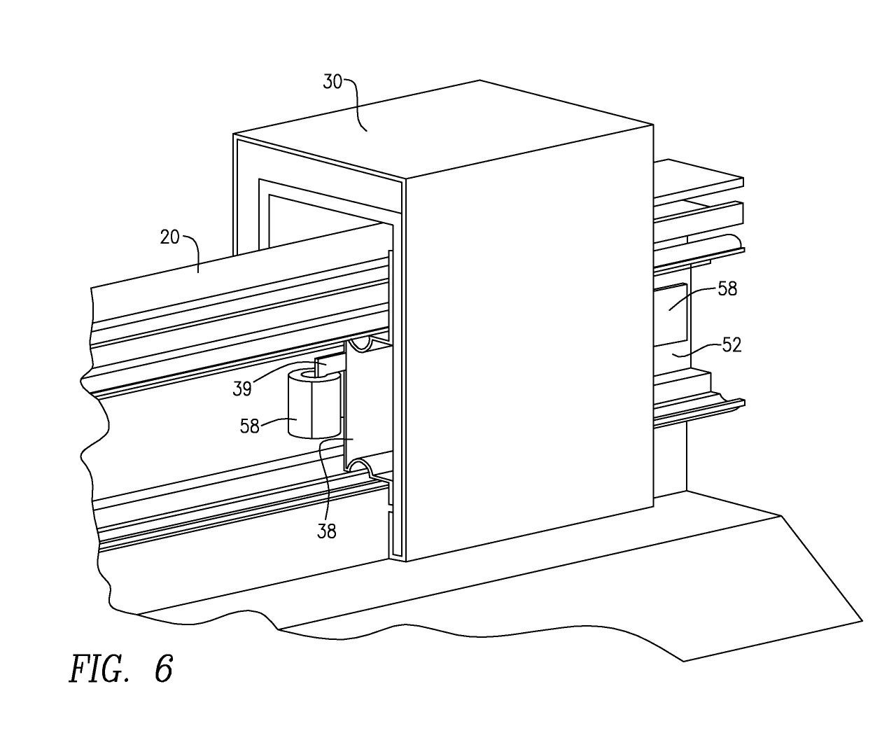

The apparatus 10 may further include a biasing element so that the sliding handle 30 remains at rest in a rearward position and under tension when moved forward, and in a detented, forward position. Now referring to FIG. 6, in one embodiment the apparatus 10 includes a spring 58, in this example a flat sheet fixed at one end of the rail 52 and spooled on a bracket 39 extending from a leading edge of the handle rail 38 operable to create a bias such that the handle 30 remains at rest in the rearward position. As the handle 30 is moved forward, the spring 58 is tensioned and when the handle 30 engages a detent 54, the handle 30 is under tension in the detented position. It will be apparent to the skilled artisan that the spring 58 may be fixed at the opposite end of the rail 52 so that the handle 30 will be at rest in the forward position and under tension in the rearward position.

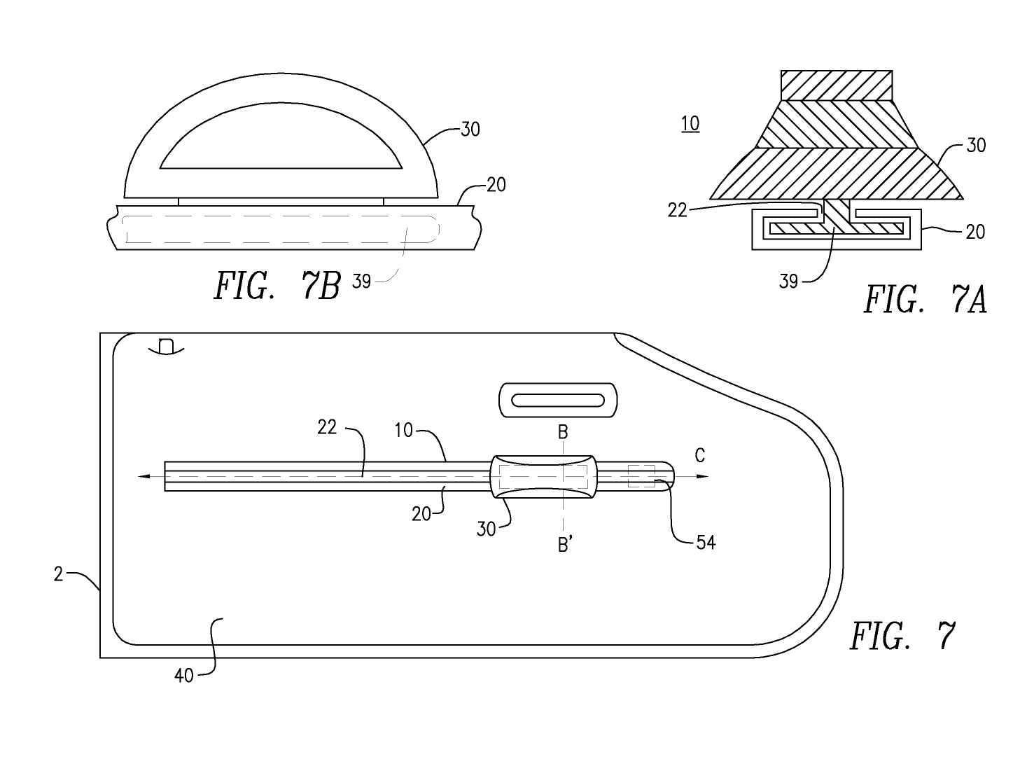

Now referring to FIG. 7, a sliding grab handle apparatus includes handle support 20 which is an elongated section having a channel 22 formed therein and handle 30 having a glide extending therefrom. In accordance with this embodiment handle support 20 is mountable to an interior surface of a vehicle door 2. With further reference to FIGS. 7A and 7B, glide 39 is slidably engaged in channel 22 so that the handle 30 may be moved fore and aft as indicated by the arrow C. An optional retention element 54 may be for example a magnet which releasably engages the handle 30 when handle 30 includes metal, and vice-versa.

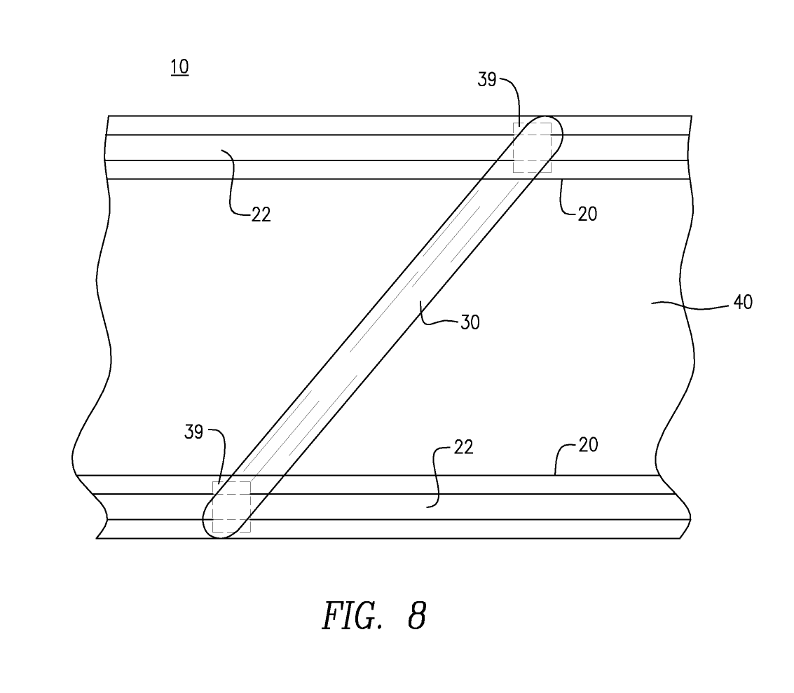

Now referring to FIG. 8, the handle support 20 may include plural elongated elements with channels 22 formed along a long axis thereof. Handle 30 may include plural glides 22 slidably mounted to the channels 22.

The subject matter disclosed herein is exceptionally beneficial to elderly passengers, children and any person who might experience difficulty opening/closing a car door. In addition, the present subject matter allows a passenger to maintain a grip on the door for a longer period of time, thus providing enhanced grip and control of a vehicle door when the door is subjected to unexpected forces such as wind gusts, downhill parking orientation and the like. The presently disclosed subject matter is particularly useful when employed in larger vehicles having heavy and/or long doors, such as large coupes and trucks.

Although the apparatus of the present disclosure have been described with reference to exemplary embodiments thereof, the present disclosure is not limited thereby. Indeed, the exemplary embodiments are implementations of the disclosed apparatus are provided for illustrative and non-limitative purposes. Changes, modifications, enhancements and/or refinements to the disclosed apparatus may be made without departing from the spirit or scope of the present disclosure. Accordingly, such changes, modifications, enhancements and/or refinements are encompassed within the scope of the present disclosure.

1. A grab handle apparatus for a vehicle door comprising
a handle support extending from a passenger compartment side of a vehicle door; and
a handle engaged only to the handle support, the handle slidably engaged to the handle support, wherein the handle is movable along at least a portion of a length of the handle support.

2. The apparatus according to claim 1 wherein the handle support comprises a forward end for mounting on a forward location of a vehicle door and a rearward end for mounting on a rearward location of the vehicle door and is mounted substantially horizontally on the vehicle door.

3. The apparatus according to claim 1 wherein the handle comprises an aperture formed along a longitudinal axis of the handle for receiving the handle support.

4. The apparatus according to claim 1 wherein the handle support comprises a handle guide extending vertically with respect to a vehicle floor, wherein the handle is disposed in slidable engagement with the handle guide.

5. The apparatus according to claim 4 further comprising a support element positioned on a side of an interior door panel that faces opposite the passenger compartment of a vehicle and operable to support the handle guide, and further comprising a handle support rail mounted along a vehicle exterior-facing side of the support element.

6. The apparatus according to claim 4 wherein the handle guide comprises an extension of an interior door panel.

7. The apparatus according to claim 1 wherein the handle comprises a substrate and at least one of an exterior skin and an intermediate layer.

8. The apparatus according to claim 5 wherein the handle comprises a handle rail mounted thereon, wherein the handle rail is oriented in operable connection with the handle support rail.

9. The apparatus according to claim 8, wherein the handle rail is coupled to the handle support rail such that the handle is slidable forward and back along the handle support rail.

10. The apparatus according to claim 1, the handle support comprising at least one retention element and the handle comprising at least one corresponding retention element wherein the retention element and corresponding retention element are operable to retain the handle in a fixed position relative to the handle support.

11. The apparatus according to claim 5, comprising at least one detent extending from the support element and at least one corresponding detent element extending from an interior surface of the handle.

12. The apparatus according to claim 10 wherein the at least one retention element is removably fixed to the handle support.

13. The apparatus according to claim 11 wherein the at least one retention element is removably fixed to the support element.

14. The apparatus according to claim 1 further comprising a biasing element operable to retain the handle at rest in a forward or rearward position.

15. The apparatus according to claim 14 wherein the biasing element comprises a spring.

16. The apparatus according to claim 8 wherein the handle support rail comprises a biasing element operably connected to the handle rail.

17. The apparatus according to claim 16 wherein the biasing element comprises a spring fixed at one end of the handle support rail and fixed at the other end to a leading edge of the handle rail.

18. The apparatus according to claim 16 further comprising at least one retention element extending from the support element and at least one corresponding retention element extending from an interior surface of the handle.

19. The apparatus according to claim 10 wherein the retention element is a detent.

20. The apparatus according to claim 10 wherein the retention element is a magnet.

21. The apparatus according to claim 1 wherein the handle support comprises at least one elongated section having at least one channel formed therein and the handle comprises at least one glide extending therefrom, wherein the at least one glide is slidably engaged with the at least one channel.

22. The apparatus according to claim 21 wherein the handle support comprises more than one channel and the handle comprises more than one glide, each glide corresponding to and engaged to a single channel.

23. A vehicle passenger door comprising a slidable grab handle apparatus comprising a handle support extending from a passenger compartment side of the vehicle door and a handle engaged only to the handle support, the handle slidably engaged to the handle support, wherein the handle is slidably movable along at least a portion of a length of the handle support, wherein the handle support comprises a forward end for mounting on a forward location of a vehicle door and a rearward end for mounting on a rearward location of the vehicle door and is mounted substantially horizontally on the vehicle door.

24. The vehicle passenger door according to claim 19 wherein the handle support comprises a handle support rail mounted thereon and the handle comprises a handle rail mounted thereon, wherein the handle rail is oriented in operable connection with the handle support rail.
